(19) United States
(12) Patent Application Publication
(10) Pub. No.: US 2003/0171525 A1
(43) Pub. Date: Sep. 11, 2003

(54) Structure-directing catalysis for synthesis of metal, non-silicon metalloid and rare earth oxides and nitrides, and their organic or hydrido conjugates and derivatives

(76) Inventors: Daniel E. Morse, Santa Barbara, CA (US); Jan L. Sumerel, Goleta, CA (US)

Correspondence Address: Robert Berliner, FULBRIGHT & JAWORSKI L.L.P., Twenty-Ninth Floor, 865 South Figueroa, Los Angeles, CA, 90017-2571, US

(21) Appl. No.: 10/278,491

(22) Filed: Oct. 22, 2002

Related U.S. Application Data
(63) Continuation-in-part of application No. 09/856,599, filed on Jul. 16, 2001.
Application No. 09/856,599 is a 371 of international application No. PCT/US99/30601, filed on Dec. 17, 1999.
(60) Provisional application No. 60/112,944, filed on Dec. 18, 1998.

(51) Int. Cl. C08G 77/00

(52) U.S. Cl. 528/10

(57) ABSTRACT

A method that utilizes a family of catalysts to produce metal, non-silicon metalloid and rare earth oxides and nitrides, and their organic or hydrido conjugates and derivatives from corresponding alkoxide-like precursors while simultaneously directing the nanostructure of the resulting material. The family of catalysts include the silicateins, a family of enzymes responsible for the structure-directing polycondensation of silica in biological systems. Silicateins catalyze the formation of structurally organized silica polymers. Other suitable catalysts include a large group of enzymes that mimic the action of silicateins, peptide biomimetics of silicateins, and other chemical entities that act catalytically by a mechanism related to that of the silicateins.

### CROSS-REFERENCE TO RELATED APPLICATIONS

This application is a Continuation-In-Part of U.S. patent application Ser. No. 09/856,599, filed Jul. 16, 2001, and is based on International Application Number PCT/US99/30601 having an international filing date of Dec. 18, 1999, which in turn claims the benefit of U.S. Provisional Patent Application No. 60/112,944, filed Dec. 18, 1998.

### STATEMENT REGARDING FEDERALLY SPONSORED RESEARCH OR DEVELOPMENT

This invention was made with Government support under Grant Nos. DMR32716 & DMR34396, awarded by the National Science Foundation. The Government has certain rights in this invention.

### BACKGROUND OF THE INVENTION

Present methods of metal oxide fabrication for the electronics and high-tech industries require capital-intensive “fabrication-line” facilities, the use of high temperatures and high vacuum, and the costly control and remediation of strong acids, bases and other toxic and dangerous chemicals. Moreover, attempts to fabricate nanoscale metal oxide features by lithographic methods of etching or stenciling are already reaching the foreseeable limits of resolution. There is a need for an economical way of micro- and nano- fabricating metal oxides without these limitations, and without the environmental hazards of present fabrication techniques, as well as for similarly fabricating other oxides and corresponding nitrides, and their organic or hydrido conjugates and derivatives, and other related materials.

There has been some success by one of us in conjunction with others in fabricating nanoscale features, but in silica, wherein we identified a family of enzymes and their biomimetics that condense silica precursors into specific morphologies or patterned structures by in vitro polymerization of silica and silicone polymer networks. This is described in parent International Application Number PCT/US99/30601, from which U.S. patent application Ser. No. 09/856,599 was filed on Jul. 16, 2001, and of which the present application is a continuation-in-part. International Application Number PCT/US99/30601 was published as International Publication Number WO 00/35993 on Jun. 22, 2000, the disclosure of which is incorporated herein by reference. That publication describes: “[m]ethods, compositions, and biomimetic catalysts, such as silicateins and block copolypeptides, used to catalyze and spatially direct the polycondensation of silicon alkoxides, metal alkoxides, and their organic conjugates to make silica, polysiloxanes, polymetallo-oxanes, and mixed poly(silicon/metallo)oxane materials under environmentally benign conditions.”

### BRIEF SUMMARY OF THE INVENTION

The present invention is directed to, and provides an unprecedented disclosure of, a family of enzymes and their biomimetics that catalyze and structurally direct the formation, not just of silicon oxide, but of other metalloid oxides as well as metal oxides, rare-earth oxides, metal nitrides, the corresponding organically substituted derivatives and related materials. Materials that can be produced using the concepts of the present invention are as varied as titanium dioxide, zinc oxide, gallium oxide, europium oxide, erbium oxide, gallium nitride, and the like.). Many of these materials are valuable semiconductors, luminescent display materials and other technologically valuable materials. As an example, titanium dioxide is used industrially as a broad-band semiconductor, as a photo-catalyst in the microelectronic industry, as a photo-voltaic (solar energy converting) material, as well as in a wide variety of other applications in coatings, cosmetics, and the like.

The examples in WO 00/35993 were all concerned with the effect of silicatein on silicon alkoxide. Therefore, what is surprising and wholly unprecedented in this invention is the demonstration of a family of catalysts that simultaneously produce other metalloid oxides, metal oxides, and related materials from the corresponding alkoxide-like precursors, while simultaneously directing the nanoscale structure of the resulting material. Silicateins, a family of other functionally related enzymes and biomimetic catalysts are used to catalyze and structurally direct the polycondensation (polymerization) of the above metal oxides and rare-earth oxides and the corresponding organically substituted materials, such as (but not confined to) poly(phenyl-titanium oxide), and the like. These materials in turn can be used as the precursors for formation of the corresponding nitrides, such as (but not confined to) gallium nitride, and the like. Catalysis of the polycondensation reaction occurs at low temperature, ambient pressure and at or, near neutral pH.

More particularly, the described method utilizes a family of catalysts that produce metal, non-silicon metalloid and rare earth oxides and nitrides, and their organic or hydrido conjugates and derivatives. from corresponding alkoxide-like precursors while simultaneously directing the nanostructure of the resulting material. The family of catalysts include the silicateins, a family of enzymes responsible for the structure-directing polycondensation of silica in biological systems. Silicateins catalyze the formation of structurally organized silica polymers. Other suitable catalysts include a large group of enzymes that mimic the action of silicateins, peptide biomimetics of silicateins, and other chemical entities that act catalytically by a mechanism related to that of the silicateins. For a further description of the catalyst, see the above-referred to WO 00/35993.

This is the first biotechnological route yet discovered for catalysis of the nanofabrication of the metal oxides (and subsequent conversion to the metal nitrides), and offers an economical and environmentally benign alternative to present methods of fabrication for the electronics and other industries which require capital-intensive “fabrication-line” facilities, and the use of high temperatures, high vacuum, and the costly control and remediation of strong acids, bases and other toxic and dangerous chemicals.

Advantages of the invention include: (a) the ability to control nanoscale features of the aforementioned materials at the time of synthesis (i.e., provide “bottom-up nanofabrication”), using structure-directing scaffolds; (b) catalysis of the synthesis of the aforementioned oxides at low temperature; (c) catalysis of the synthesis of the aforementioned oxides at ambient pressure, and (d) catalysis of the synthesis of the aforementioned oxides at or near neutral pH.

The potential value for semiconductor and electronic/luminescent display manufacture is significant: rather than attempting to “etch down” or stencil nanoscale features of these materials (by lithographic methods already reaching the foreseeable limits of resolution) to make smaller and faster components, the invention disclosed here offers the possibility of constructing nanoscale features of these materials “from the bottom up”—an objective of high priority in the National and International Semiconductor Roadmap.

### BRIEF DESCRIPTION OF THE DRAWINGS

For a more complete understanding of the present invention, reference is now made to the following descriptions taken in conjunction with the accompanying drawing, in which:

FIG. 1 is the structural formula for titanium (iv)bis(ammonium lactato)-dihydroxide (TBALDH);

FIG. 2A is a scanning electron microscope image of the result of catalyzing TBALDH hydrolysis and polycondensation with silicatein proteins;

FIG. 2B is a scanning electron microscope image of the result of catalyzing TBALDH hydrolysis and polycondensation with sodium hydroxide;

FIG. 3 shows four scanning electron microscope images of a titanium dioxide hybrid obtained by reacting TBALDH with silicatein proteins;

FIG. 4 is an energy dispersive spectrometer spectrum of a titanium dioxide hybrid prepared as in FIG. 2A;

FIG. 5 shows an X-ray photoelectron spectroscopy spectrum of samples prepared as in FIG. 4;

FIG. 6 shows the fluorescence of silicatein/TiO₂ combinations or hybrids after excitation at 280 nm, where A is the silicatein plus TBALDH, B is the denatured silicatein plus TBALDH, C is the silicatein alone, D is denatured silicatein alone, and E is TBALDH;

FIG. 7 shows thermal annealing to anatase and rutile wherein the reactions were performed as in FIG. 2 and subsequently heated; and

FIG. 8 is a table showing polymorph and crystal size resulting from annealing TiO₂ synthesized from TBALDH with silicatein protein catalyst, ammonium hydroxide catalyst, and with heat alone.

### DETAILED DESCRIPTION OF THE INVENTION

The nanostructure-directing catalysts covered by this invention includes the following

(1) Any of the Silicateins—a family of enzymes we discovered responsible for the structure-directing polycondensation of silica in biological systems. See:

Shimizu, K., J. Cha, Y. Zhou, G. D. Stucky and D. E. Morse. 1998. Silicatein α: Cathepsin L-like protein in sponge biosilica. Proc. Natl. Acad. Sci. USA 95: 6234-6238; and Cha, J. N., K. Shimizu, Y. Zhou, S. C. Christiansen, B. F. Chmelka, G. D. Stucky and D. E. Morse. 1999. Silicatein filaments and subunits from a marine sponge direct the polymerization of silica and silicones in vitro. Proc. Natl. Acad. Sci USA 96: 361-365. Each of the foregoing references is incorporated herein by reference.

(2) Any of the large family of enzymes that works by a mechanism functionally related to that of the silicateins. See:

Zhou, Y., K. Shimizu, J. N. Cha, G. D. Stucky and D. E. Morse. 1999. Efficient catalysis of polysiloxane synthesis by silicatein a requires specific hydroxy and imidazole functionalities. Angewandte Chemie Intl. Ed. 38: 779-782; Morse, D. E. 1999. Silicon biotechnology: Harnessing biological silica production to make new materials. Trends in Biotechnology, 17: 230-232; Morse, D. E. 2000. Silicon biotechnology: Proteins, genes and molecular mechanisms controlling biosilica nanofabrication offer new routes to polysiloxane synthesis. In: “Organosilicon Chemistry IV: from Molecules to Materials” (N. Auner and J. Weis, eds.); Wiley-VCH, New York, pp. 5-16.; Morse, D. E. 2001. Biotechnology reveals new routes to synthesis and structural control of silica and polysilsesquioxanes. In: “The Chemistry of Organic Silicon Compounds” (Z. Rappoport and Y. Apeloig, eds.); John Wiley & Sons, New York, vol. 3, pp. 805-819. Each of the foregoing references is incorporated herein by reference.

Such enzymes include those known as hydrolases, esterases, amidases; lipases, proteases, peptidases, “catalytic triad enzymes”; and any other enzyme functionally related to the above through a similar mechanism of action.

(3) Any of the self-assembling peptides related to those we synthesized and demonstrated capable of acting as biomimetic substitutes for the silicateins. See:

Cha, J. N., G. D. Stucky, D E. Morse, T. J. Deming. 2004. Biomimetic synthesis of ordered silica structures by block copolypeptides. Nature 403: 289-292, incorporated herein by reference.

Such peptides include, but are not confined to, those containing a nucleophilic residue such as cysteine, serine, threonine or tyrosine, and a hydrogen-bonding amine such as histidine, lysine or arginine.

(4) Any non-peptide-based synthetic polymers containing a nucleophilic group and a hydrogen bonding amine such that the polymer functions by a mechanism of action related to that of the silicateins.

(5) Any such chemical functionality as a nucleophilic group and or a hydrogen bonding amine which, acting in concert with nanoconfinement and or chemical functionality of the surface or matrix to which the functionality is attached, acts catalytically by a mechanism related to that of the silicateins.

Any of the catalysts described above may be used to react with the precursor. When the catalyst used is a silicatein, it may be used as the enzyme monomers, made either by purification from the biological source as previously described. See:

Shimizu, K., J. Cha, Y. Zhou, G. D. Stucky and D. E. Morse. 1998. Silicatein or Cathepsin L-like protein in sponge biosiliea. Proc. Natl. Acad. Sci. USA A 95: 6234-6238; and Cha, IN., K. Shimizu, Y. Zhou, S. C. Christiansen, B. F. Chmelka, G. D. Stucky and D. S. Morse. 1999. Silicatein filaments and subunits from a marine sponge direct the polymerization of silica and silicones in vitro. 96: 361-365), Proc. Natl. Acad. Sci. USA 96:361-365. Each of the foregoing references is incorporated herein by reference.

Alternatively, the silicatein may be obtained from the cloned recombinant DNA templates. See:

Zhou, Y., K. Shimizu, J. N. Cha, G. D. Stucky and D. E. Morse. 1999. Efficient catalysis of polysiloxane synthesis by silicatein a requires specific hydroxy and imidazole functionalities, Antzewandte Chemie Intl. Ed. 38: 779-782; Morse, D. E. 1999, incorporated herein by reference.

The silicatein is used in conjunction with an anchoring support surface or matrix, or it may be used as the polymeric multi-enzyme filaments extracted from the biological source as described in the references cited immediately above, or constituted from monomers made from the filaments or from recombinant DNA templates.

Any metal or non-silicon metalloid alkoxide-like precursor can be used, including the following:

the transition metals, such as scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, and mercury;

the lanthanide series of the rare earth metals, such as lanthanum, cerium, praseodymium, neodymium, promethium, samarium, europium, gadolinium, terbium, dysprosium, holmium, erbium, thulium, ytterbium, and lutetium;

the actinide series of the rare earth metals, such as actinium, thorium, protactinium, uranium, neptunium, plutonium, americium, curium, berkelium, and californium;

the alkaline earth metals, such as beryllium, magnesium, calcium, strontium, barium, and radium;

the alkali metals, such as lithium, sodium, potassium, rubidium, and cesium;

other metals, such as aluminum, gallium, indium, tin, thallium, lead, and bismuth; and

the non-silicon metalloids, such as boron, germanium, arsenic, antimony, tellurium, and polonium.

The catalyst used in this invention comprises a molecule having a nucleophilic group that displaces alkanol from an alkoxide or alkoxide-like substrate facilitating solvolysis to initiate structure-directed hydrolysis and subsequent condensation with another alkoxide or alkoxide-like material at neutral or near neutral pH to form a dioxane, oligo-oxane, or polyoxane product. The structure-directed condensation is by nucleophilic attack wherein the nucleophilic group forms a, preferably covalent, transitory intermediate in facilitating solvolysis. Preferably, the catalyst comprises a group that interacts with the nucleophilic group to increase its nucleophilicity, e.g., by hydrogen bonding. In particular embodiments, the catalyst is selected from the group consisting essentially of silicatein, protein, enzyme, peptide, and non-peptide-based polymers, any small molecule containing the essential functionalities described above, and/or any aggregate, filament, or other assembly thereof. The nucleophilic group of the catalyst can be provided by a hydroxyl or sulfhydryl group.

Either or both of the alkoxides or alkoxide-like material is selected from the group consisting essentially of metallo alkoxides, non-silicon metalloid alkoxides, and organic or hydrido conjugates of the foregoing, to form the corresponding polymetallo-oxanes, non silicon polymetalloid-oxanes, or the corresponding organic or hydrido conjugates of the foregoing.

In one embodiment, the nucleophile-containing catalyst is a protein, more preferably, an enzyme such as a silicatein, a protease, a peptidase, a hydrolase (e.g., selected from the group consisting essentially of amidase, esterase and lipase), a catalytic triad enzyme.

In another embodiment, the nucleophile-containing catalyst is a peptide. The peptide can contain lysine or poly-lysine, serine or poly-serine, or a tyrosine, a histidine, or cysteine, oligocysteine or poly-cysteine. The peptide can contain a nucleophilic catalytic side-chain, for example, contributed by serine, cysteine, histidine or tyrosine, or it can contain a hydrogen-bonding amine.

In another embodiment, the nucleophile-containing catalyst is a non-peptide-based polymer that operates by a mechanism of catalysis similar to that utilized by silicateins. The non-peptide-based polymer can contain a hydrogen-bonding amine and/or a nucleophilic group.

In a particular embodiments, either or both of the alkoxides or alkoxide-like material is a metallo alkoxide, a non-silicon metalloid alkoxide, an organometallo-alkoxide, or an non-silicon organometalloid alkoxide. The product of the catalysis depends, of course, on the precursor, and can be a polymetallo-oxane, a non silicon non-silicon polymetalloid-oxane, a polyorganometallo-oxane, or a non-silicon polyorganometalloid-oxane.

The molecule of the catalyst when macromolecular is preferably self-assembling whereby structure-directed condensation is provided by a spatial array of structure-directing determinants contained on or within the self-assembling molecule. The spatial array of structure-directing determinants acts in conjunction with the surfaces of any mesoporous or other solid support to which the molecule is attached or in which the molecule is confined.

A typical reaction with silicatein in the polymeric multi-enzyme filament form is described, using a precursor to form nanostructurally directed titanium dioxide, as described in the following examples. Alternatively, other metal, non-silicon metalloid, or rare-earth alkoxide or alkoxide-like precursor, can be used.

### EXAMPLE 1

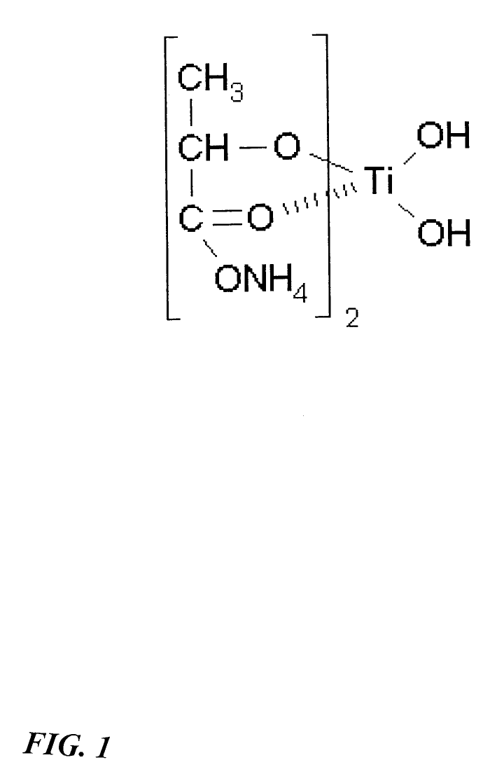

Silicatein filaments (2 mm length×1-2 micrometer diameter) were suspended in water at room temperature and reacted with titanium (IV)bis(ammonium lactato)-dihydroxide (TBALDH), the structure of which is illustrated in FIG. 1. The final molarity of the Titanium alkoxide in the example illustrated was 0.849 M. Biphasic reaction mixtures in which the precursor is added in an organic solvent also are effective. The mixture was rotated to provide gentle agitation in a 1 ml polyethylene comical tube for 24 hours. The reaction product was then harvested by centrifugation in an Eppendorf microcentrifuge at 14,000 rpm for 10 minutes, re-suspended in water and pelleted by centrifugation again for another 10 minutes. The resulting pellets were dried at 37 degrees C. Physical characterization identified the product as Titanium Dioxide that had been formed on the silicatein filaments.

### EXAMPLE 2

In contranst to Example 1, as a control, equal parts of 1N sodium hydroxide and aqueous TBALDH were reacted at room temperature. The final molarity of the Titanium alkoxide in the example illustrated was 0.849 M. Biphasic reaction mixtures in which the TBALDH precursor is added in an organic solvent also are effective. The mixture was rotated to provide gentle agitation in a 1 ml polyethylene comical tube for 24 hours. The reaction product was then harvested by centrifugation in an Eppendorf microcentrifuge at 14,000 rpm for 10 minutes, re-suspended in water and pelleted by centrifugation again for another 10 minutes. The resulting pellets were dried at 37 degrees C.

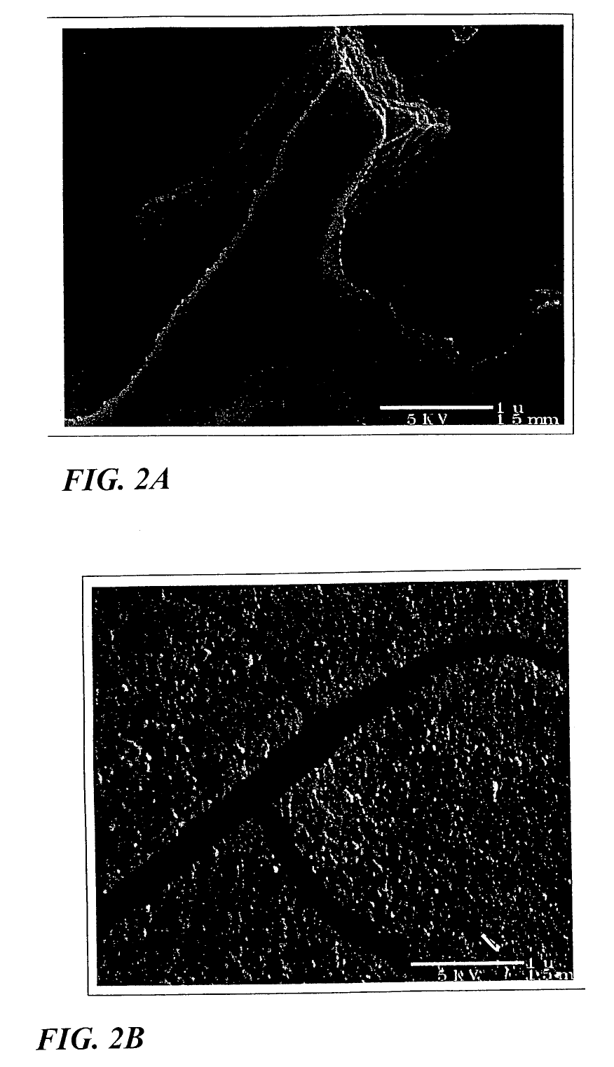

Referring to FIGS. 2A and 2B, samples from the procedures of Examples 1 and 2 were washed three times in deionized water and then mounted on SEM carbon grids, gold sputter coated, and imaged by scanning electron microscopy with a JEOL JSM 6300 F. The sample of FIG. 2A was obtained using silicatein filaments as the catalyst in the procedure of Example 1. The sample of FIG. 2B was obtained using NaOH as the catalyst in the procedure of Example 2. It is seen in the electron micrograph of FIG. 2 that the Titanium Dioxide product formed on the silicatein filaments and followed the contours of the silicatein filaments, which served both as a structure-directing template and as a catalyst:

### EXAMPLE 3

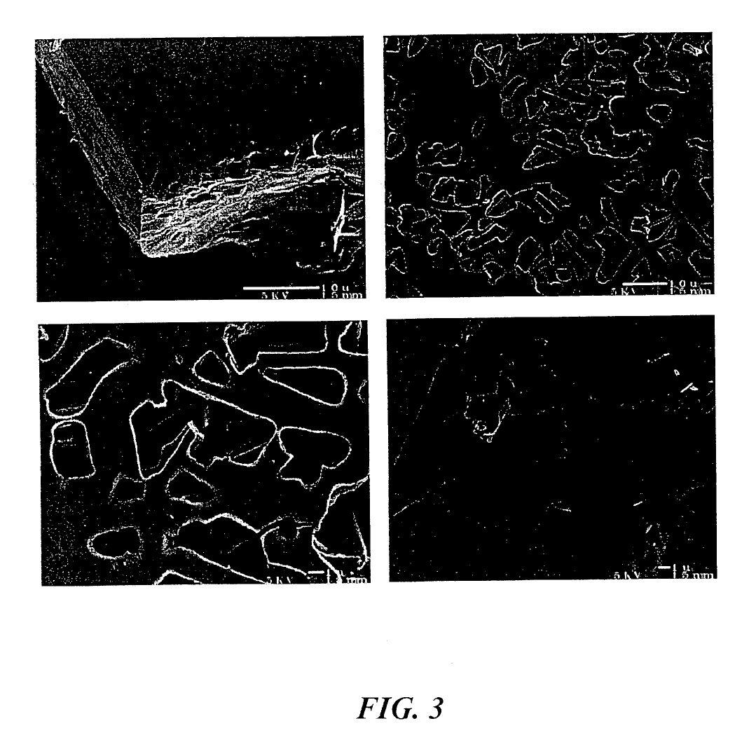

The procedure of Example 2 was repeated and additional SEM images were obtained. Different regions of the produced material are shown in FIG. 3, which shows 1 and 10 micron scales.

### EXAMPLE 4

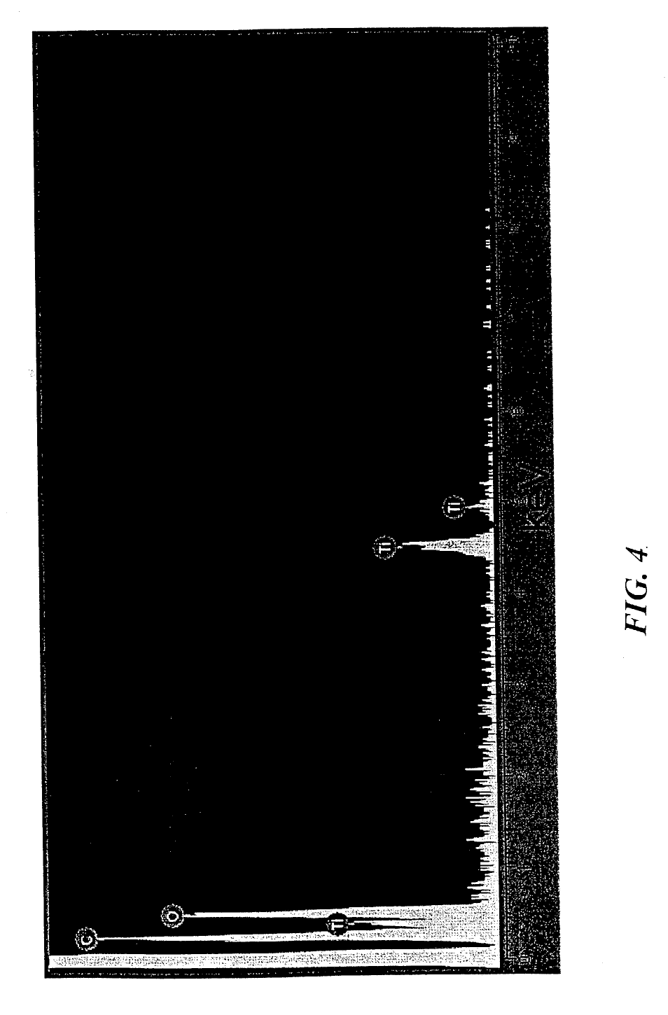

The procedure of Example 2 was repeated and samples were prepared as described with respect to FIGS. 2A and 2B, except that sputter coating was not performed. A JEOL 6300F scanning electron microscope with an integrated JEOL Energy dispersive spectrometer (EDS) was used. The electron microprobe was coupled to the diffraction x-rays of a range of wavelengths on a gas-flow detector. The spectrum is shown in FIG. 4 wherein C=carbon, O=oxygen, and Ti=titanium. The x-axis is in keV, and the y-axis non-quantitatively signifies relative intensities.

### EXAMPLE 5

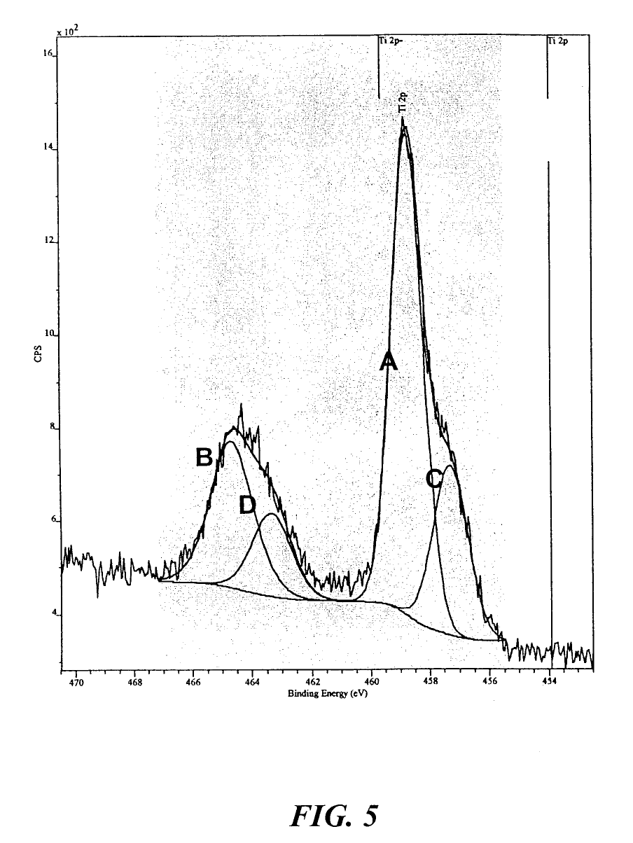

Samples were prepared as in Example 4. Referring to FIG. 5, the resulting peak shapes of measured spectra were quantified and the quantitative composition of the surface was determined.

### EXAMPLE 6

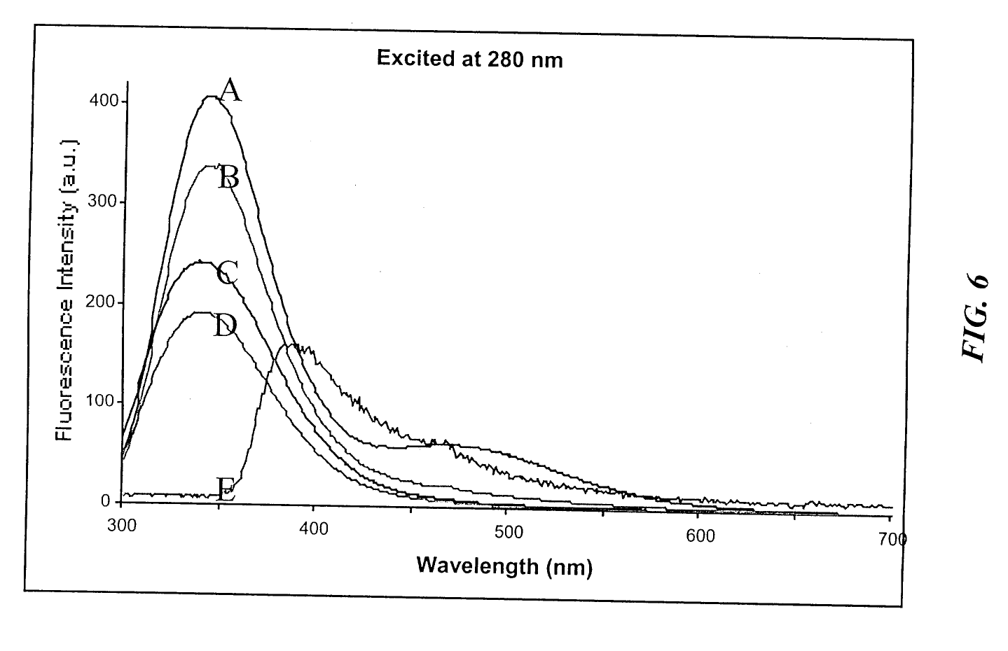

Samples were prepared following the procedure of Example 1 to provide permutations of TBALDH, silicatein filaments, denatured silicatein filaments and their combinations. The silicatein filaments were denatured by heating in water at 95 degrees C. for one hour. FIG. 6 shows the fluorescence of filament/TiO₂ combinations or hybrids after excitation at 280 nm, where A is the filament plus TBALDH, B is the denatured filament plus TBALDH, C is the filament alone, D is the denatured filament alone, and E is TBALDH.

### EXAMPLE 7

To convert the material to the nitride if desired (e.g., to form Gallium Nitride from the Gallium Oxide or amorphous Gallium Oxane) the GaO product of the catalytic reaction described above is subjected to transamidation with ammonia in a high-pressure cell or pressure bomb.

### EXAMPLE 8

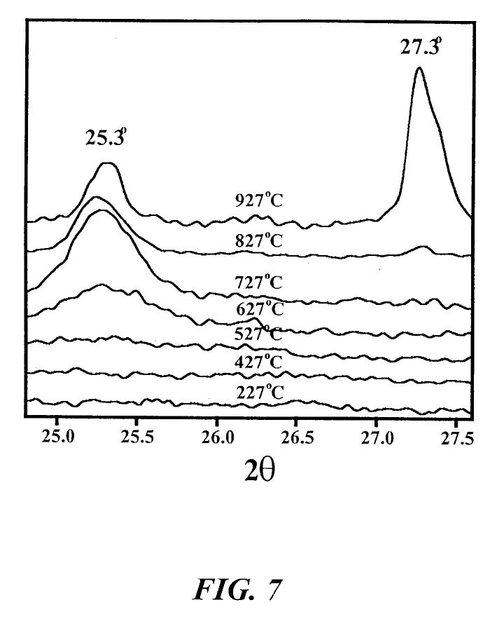

Thermal annealing can be used to convert the initially amorphous metallo-oxane or rare-earth oxane to the crystalline material. The following example illustrates thermal annealing to form anatase and/or rutile forms of titanium dioxide. Initial reactions were performed as in Example 1. After washing, samples were dried at 37° C. overnight and ground in an agate mortar to a fine powder. Samples were applied to a heated stage, and the x-ray diffraction pattern was obtained on a Siemens D5005 instrument using Cu Kα radiation. Heating was done in a stepwise manner, in 100° C. increments from ambient temperature to 927° C. FIG. 7 shows the obtained data starting from 227° C.; the ordinate in this figure shows the intensity of X-ray diffraction in arbitrary units.

### EXAMPLE 9

Product was formed following the procedure of Example 1 with silicatein protein catalyst. The product was thermally annealed following the procedure of Example 8.

### EXAMPLE 10

Product was formed following the procedure of Example 2 except the base catalyst was ammonium hydroxide catalyst. The product was thermally annealed following the procedure of Example 8.

### EXAMPLE 11

Product was formed following the procedure of Example 2 with only heat as the catalyst. The product was thermally annealed following the procedure of Example 8.

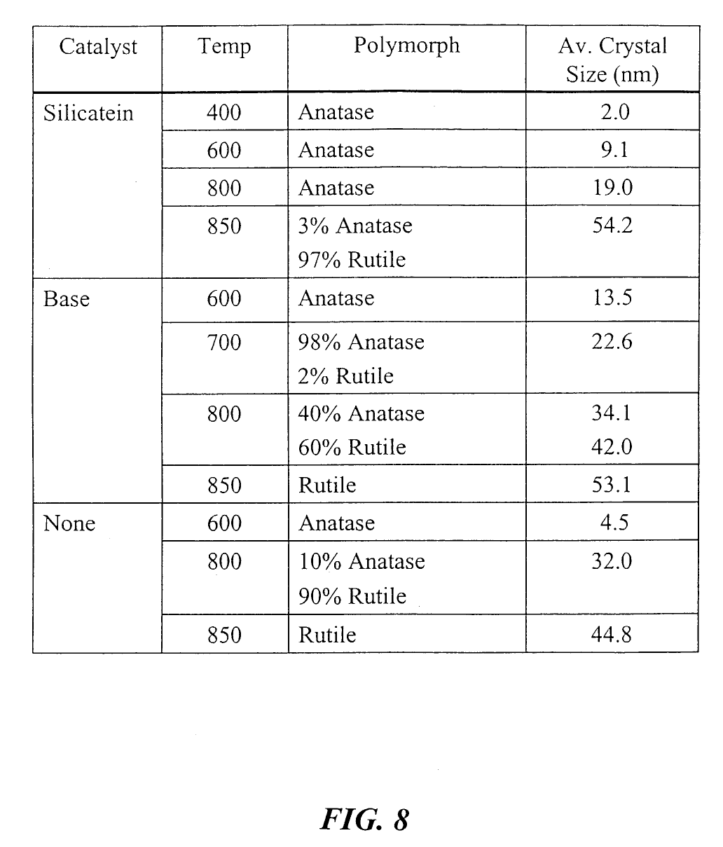

FIG. 8 is a table showing polymorph and crystal size resulting from the annealing of Examples 9, 10 and 11., respectively with silicatein protein catalyst, sodium hydroxide catalyst, and heat as the catalyst.

Although the present invention and its advantages have been described in detail, it should be understood that various changes, substitutions and alterations can be made herein without departing from the spirit and scope of the invention. Moreover, the scope of the present application is not intended to be limited to the particular embodiments of the process, methods and steps described in the specification. As one of ordinary skill in the art will readily appreciate from the disclosure of the present invention, processes, methods, or steps, presently existing or later to be developed that perform substantially the same function or achieve substantially the same result as the corresponding embodiments described herein may be utilized according to the present invention. Accordingly, the appended claims are intended to include within their scope such processes, methods, or steps.

1. A catalyst comprising a molecule having a nucleophilic group that displaces alkanol from a non-silicon alkoxide or alkoxide-like substrate facilitating solvolysis to initiate structure-directed condensation with another non-silicon alkoxide or alkoxide-like material at neutral or near neutral pH to form a dioxane, oligo-oxane, or polyoxane product.

2. The catalyst of claim 1 wherein said structure-directed condensation is by nucleophilic attack.

3. The catalyst of claim 1 wherein said nucleophilic group forms a transitory intermediate in facilitating solvolysis.

4. The catalyst of claim 3 wherein said transitory intermediate is covalent.

5. The catalyst of claim 1 comprising a group that interacts with said nucleophilic group to increase its nucleophilicity.

6. The catalyst of claim 5 wherein said interaction is by hydrogen bonding.

7. The catalyst of claim 1 wherein either or both of said alkoxides or alkoxide-like material is selected from the group consisting essentially of metallo alkoxides, non-silicon metalloid alkoxides, and organic or hydrido conjugates of the foregoing, to form the corresponding polymetallo-oxanes, non-silicon polymetalloid-oxanes, or the corresponding organic or hydrido conjugates of the foregoing.

8. The catalyst of claim 1 wherein said molecule is a protein.

9. The catalyst of claim 1 wherein said molecule is an enzyme.

10. The catalyst of claim 9 wherein said enzyme is a silicatein.

11. The catalyst of claim 9 wherein said enzyme is a protease.

12. The catalyst of claim 9 wherein said enzyme is a peptidase.

13. The catalyst of claim 9 wherein said enzyme is a hydrolase.

14. The catalyst of claim 13 wherein said hydrolase is selected from the group consisting essentially of amidase, esterase and lipase.

15. The catalyst of claim 9 wherein said enzyme is a catalytic triad enzyme.

16. The catalyst of claim 1 wherein said molecule is a peptide.

17. The catalyst of claim 16 wherein said peptide contains lysine or poly-lysine.

18. The catalyst of claim 16 wherein said peptide contains serine or poly-serine.

19. The catalyst of claim 16 wherein said peptide contains a tyrosine.

20. The catalyst of claim 16 wherein said peptide contains a histidine.

21. The catalyst of claim 16 wherein said peptide contains cysteine, oligocysteine or poly-cysteine.

22. The catalyst of claim 16 wherein said peptide contains a nucleophilic catalytic side-chain

23. The catalyst of claim 22 wherein said nucleophilic catalytic side-chain is contributed by serine, cysteine, histidine or tyrosine.

24. The catalyst of claim 16 wherein said peptide contains a hydrogen-bonding amine.

25. The catalyst of claim 1 wherein said molecule is a non-peptide-based polymer that operates by a mechanism of catalysis similar to that utilized by silicateins.

26. The catalyst of claim 25 wherein said non-peptide-based polymer contains a hydrogen-bonding amine and/or a nucleophilic group.

27. The catalyst of claim 1 wherein either or both of said alkoxides or alkoxide-like material is a metallo alkoxide.

28. The catalyst of claim 1 wherein either or both of said alkoxides or alkoxide-like material is an organometallo-alkoxide or hydrido metallo-alkoxide.

29. The catalyst of claim 1 wherein either or both of said alkoxides or alkoxide-like material is a non-silicon metalloid alkoxide.

30. The catalyst of claim 1 wherein either or both of said alkoxides or alkoxide-like material is a non-silicon organometalloid alkoxide or hydrido metalloid alkoxide.

31. The catalyst of claim 27 wherein said product is a polymetallo-oxane.

32. The catalyst of claim 28 wherein said product is a polyorganometallo-oxane or polyhydridometallo-alkoxide.

33. The catalyst of claim 30 wherein said product is a non-silicon polyorganometalloid-oxane or polyhydridometalloid-oxane.

34. The catalyst of claim 1 in which said molecule is self-assembling whereby said structure-directed condensation is provided by a spatial array of structure-directing determinants contained on or within the self-assembling molecule.

35. The catalyst of claim 34 in which said spatial array of structure-directing determinants acts in conjunction with the surfaces of any mesoporous or other solid support to which said molecule is attached or in which said molecule is confined.

36. The catalyst of claim 34 wherein said molecule is selected from the group consisting essentially of silicatein, protein, enzyme, peptide, and non-peptide-based polymers, or small molecules, and/or any aggregate, filament, or other assembly thereof.

37. The catalyst of claim 1 in which said nucleophilic group is provided by a hydroxyl or sulfhydryl group.

38. A catalyst comprising:
a molecule or self-assembling molecule having a nucleophilic group that displaces alkanol from a non-silicon alkoxide or alkoxide-like substrate by forming a transitory covalent intermediate facilitating solvolysis to initiate condensation with another non-silicon alkoxide or alkoxide-like material at neutral or near neutral pH with structure-directing control of product formation resulting from a spatial array of structure-directing determinants contained on or within the self-assembling molecule acting in conjunction with the surfaces of any mesoporous or other solid support to which said molecule is attached or in which said molecule is confined, to form a dioxane, oligo-oxane, or polyoxane product;
said molecule being selected from the group consisting essentially of silicatein, protein, enzyme, peptide, and non-peptide-based polymers, that operates by a mechanism of catalysis similar to that utilized by silicateins; and
either or both of said alkoxides or alkoxide-like material being selected from the group consisting essentially of metallo alkoxides, non-silicon metalloid alkoxides, and organic or hydrido conjugates of the foregoing, to form the corresponding polymetallo-oxanes, non-silicon polymetalloid-oxanes, or the corresponding organic or hydrido conjugates of the foregoing;
wherein said product is a polymetallo-oxane, a polyorganometallo-oxane, a non-silicon polymetalloid-oxane, or a non-silicon polyorganometalloid-oxane.

39. The catalyst of claim 38 comprising a group that interacts by hydrogen bonding with said nucleophilic group to increase its nucleophilicity.

40. The catalyst of claim 38 in which said nucleophilic group is provided by a hydroxyl or sulfhydryl group.
